(19) United States
(12) Patent Application Publication
(10) Pub. No.: US 2007/0011121 A1
(43) Pub. Date: Jan. 11, 2007

(54) System and method for learning rankings via convex hull separation

(76) Inventors: Jinbo Bi, Exton, PA (US); Glenn Fung, Madison, WI (US); Sriram Krishnan, Exton, PA (US); Balaji Krishnapuram, Phoenixville, PA (US); R. Bharat Rao, Berwyn, PA (US); Romer E. Rosales, Downingtown, PA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/444,606

(22) Filed: Jun. 1, 2006

Related U.S. Application Data
(60) Provisional application No. 60/687,540, filed on Jun. 3, 2005.

(51) Int. Cl. G06F 15/18

(52) U.S. Cl. 706/20

(57) ABSTRACT

A method for finding a ranking function ƒ that classifies feature points in an n-dimensional space includes providing a plurality of feature points xₖ derived from tissue sample regions in a digital medical image, providing training data A comprising training samples A^{j} where

$$A = {⋃}_{j = 1}^{S} ( {A}^{j} = {\{ {x}_{i}^{j} \}}_{i = 1}^{{m}_{j}} ) ,$$

providing an ordering E={(P,Q)|A^{P} [symbol] A^{Q}} of at least some training data sets where all training samples xᵢεA^{P} are ranked higher than any sample xⱼεA^{Q}, solving a mathematical optimization program to determine the ranking function ƒ that classifies said feature points x into sets A. For any two sets Aⁱ, A^{j}, Aⁱ [symbol] A^{j}, and the ranking function ƒ satisfies inequality constraints ƒ(xᵢ)≦ƒ(xⱼ) for all xᵢεconv(Aⁱ) and xⱼεconv(A^{j}), where conv(A) represents the convex hull of the elements of set A.

### CROSS REFERENCE TO RELATED UNITED STATES APPLICATIONS

This application claims priority from “A Convex Hulls Separation Algorithm for Ranking”, U.S. Provisional Application No. 60/687,540 of Fung, et al., filed Jun. 3, 2005, the contents of which are incorporated herein by reference.

### TECHNICAL FIELD

This invention is directed to the automatic ranking and classification of digital data, in particular for identifying features and objects in digital medical images.

### DISCUSSION OF THE RELATED ART

Physicians and scientists have long explored the use of artificial intelligence systems in medicine. One area of research has been building computer-aided diagnosis (CAD) systems for the automated interpretation and analysis of medical images, in order to classify and identify normal and abnormal features in a dataset. For example, such systems could be used for classifying and identifying polyps, tumors, and other abnormal growths from normal tissue in a digital medical image of a patient.

Many machine learning applications useful for the automated interpretation of medical images depend on accurately ordering the elements of a set based on the known ordering of only some of its elements. A known ordering of this type can arise from a physician's ranking of objects in an image as being abnormal, for example, a polyp or a tumor. In this type of situation, the physician assigns a ranking, for example a number between 1 and 10, of an object being abnormal, with a 1 indicating that the object is not abnormal, and a 10 indicating that the object is almost certainly abnormal. In the literature, variants of this problem have been referred to as ordinal regression, ranking, and learning of preference relations. Formally, the goal is to find a function ƒ: [symbol] ⁿ→ [symbol] such that, for a set of test samples {xₖε [symbol] ⁿ}, the output of the function ƒ(xₖ) can be sorted to obtain a ranking. In order to learn such a function there is provided training data, A, containing S sets (or classes) of training samples:

$$A = {⋃}_{j = 1}^{S} ( {A}^{j} = {\{ {x}_{i}^{j} \}}_{i = 1}^{{m}_{j}} ) ,$$

where the j-th set A^{j} contains mⱼ samples, so that there is a total of

$$m = {\sum }_{j = 1}^{S} {m}_{j}$$

samples in A. Further, there is also provided a directed order graph G=(V, E) each of whose vertices corresponds to a class A^{j}, and the existence of a directed edge from A^{P} to A^{Q}, denoted E_{PQ}, signifies that all training samples xᵢεA^{P} should be ranked higher than any sample xⱼεA^{Q}: i.e. ∀(xᵢεA^{P}, xⱼεA^{Q}), ƒ(xᵢ)≦ƒ(xⱼ).

In general the number of constraints on the ranking function grows as O(m²) so that naive solutions are computationally infeasible even for moderate sized training sets with a few thousand samples. One approach used a non-parametric Bayesian model for ordinal regression based on Gaussian processes. Inference in this model is computationally intractable; thus it was necessary to employ approximate inference methods (EP and Laplace approximations), although GP's are not restricted to these.

The problem of learning rankings was first treated as a classification problem on pairs of objects and subsequently used on a web page ranking task. The major advantage of this approach is that it considers a more explicit notion of ordering; however, the naive optimization strategy proposed there suffers from the O(m²) growth in the number of constraints previously mentioned. This computational burden renders these methods impractical even for medium sized datasets with a few thousand samples. In other related work, boosting methods have been proposed for learning preferences, and a combinatorial structure called the ranking poset was used for conditional modeling of partially ranked data in the context of combining ranked sets of web pages produced by various web page search engines. A different type of approach uses a neural network to rank the inputs.

### SUMMARY OF THE INVENTION

Exemplary embodiments of the invention as described herein generally include methods and systems for learning ranking functions from order constraints between sets or classes of training samples. In particular, constraints on the ranking function are modified to: ∀(xᵢεconv(A^{P}), xⱼεconv(A^{Q})), ƒ(xᵢ)≦ƒ(xⱼ), where conv(A^{j}) denotes the set of all points in the convex hull of A^{j}. This leads to: (1) a family of approximations to the original problem; and (2) considerably more efficient solutions that still enforce all of the original inter-group order constraints. Notice that this formulation subsumes the standard ranking problem as a special case when each set A^{j} is reduced to a singleton, and the order graph is equal to a full graph. A ranking algorithm according to an embodiment of the invention penalizes wrong orderings of pairs of training instances in order to learn ranking functions, but in addition, utilizes the notion of a structured class order graph. Nevertheless, using a formulation based on constraints over convex hulls of the training classes avoids the prohibitive computational complexity of the previous algorithms for ranking.

FIGS. 1(a)-(f) illustrate the types of graphs that can be incorporated into a ranking method according to an embodiment of the invention, in particular, various instances consistent with the training set {v, w, x, y, z} satisfying v>w>x>y>z. Each problem instance is defined by an order graph. FIGS. 1(a)-(d) depict a succession of order graphs with an increasing number of constraints. FIGS. 1(e)-(f) illustrate two order graphs defining the same partial ordering but different problem instances. As illustrated in FIG. 1, a ranking formulation according to an embodiment of the invention does not require a total ordering of the sets of training samples A^{j} in that it allows any order graph G to be incorporated into the problem.

Ranking algorithms according to embodiments of the invention can be used for maximizing the generalized Wilcoxon Mann Whitney statistic that accounts for the partial ordering of the classes. Special cases include maximizing the area under the receiver-operating-characteristic (ROC) curve for binary classification and its generalization for ordinal regression. Experiments on public benchmarks indicate that: (1) an algorithm according to an embodiment of the invention is at least as accurate as the current state-of-the-art; and that (2) computationally, it is several orders of magnitude faster and, unlike current methods, can easily handle large datasets with over 20,000 samples.

According to an aspect of the invention, there is provided a method for finding a ranking function ƒ that classifies feature points in an n-dimensional space, the method including providing a plurality of feature points xₖ in an n-dimensional space Rⁿ, providing training data A comprising a plurality of sets of training samples A^{j} wherein

$$A = {⋃}_{j = 1}^{S} ( {A}^{j} = {\{ {x}_{i}^{j} \}}_{i = 1}^{{m}_{j}} ) ,$$

wherein S is a number of sets and a j^{th} set A^{j} includes mⱼ samples xᵢ^{j}, providing an ordering E={(P,Q)|A^{P} [symbol] A^{Q}} of at least some of said training data sets wherein all training samples xᵢεA^{P} are ranked higher than any sample xⱼεA^{Q}, solving a mathematical optimization program to determine said ranking function ƒ that classifies said feature points x into said plurality of sets A, wherein for any two sets Aⁱ, A^{j}, wherein Aⁱ [symbol] A^{j}, the ranking function ƒ satisfies inequality constraints ƒ(xᵢ)≦ƒ(xⱼ) for all xᵢεconv(Aⁱ) and xⱼεconv(A^{j}), wherein conv(A) represents the convex hull of the elements of set A.

According to a further aspect of the invention, the ranking function is a linear function of the feature points x of the form w′x, wherein w is an n-dimensional vector.

According to a further aspect of the invention, the mathematical optimization program includes slack variables y greater or equal to zero for non-separable sets wherein not all inequality constraints can be satisfied, wherein said slack variables are a measure of the extent to which constraints are violated in said mathematical program.

According to a further aspect of the invention, the method comprises one slack variable yⁱ for each of said training samples xᵢ, wherein any training sample point inside the convex hull of any set is associated with a slack variable equal to a convex combination of yⁱ with coefficients λ.

According to a further aspect of the invention, the mathematical program is of form

$${min}_{\{ w , {y}^{i} , {y}^{ij} \vert ( i , j ) ∈ E \}} v {‖ y ‖}^{2} + \frac{1}{2} {w}^{′} w$$

such that the equation set Qᵢⱼ is satisfied ∀(i,j)εE, wherein w is an n-dimensional vector, v is real number controlling the trade off between the two terms, equation set Qᵢⱼ is

$${Q}_{ij} ≡ \{ \begin{matrix}\begin{matrix}\begin{matrix}{γ}^{ij} + K ( {A}^{i} , {A}^{′} ) v + {y}^{i} \geq 0 \\ {\hat{γ}}^{ij} - K ( {A}^{j} , {A}^{′} ) v + {y}^{j} \geq 0\end{matrix} \\ {γ}^{ij} + {\hat{γ}}^{ij} \leq - 1\end{matrix} \\ {y}^{i} , {y}^{j} \geq 0\end{matrix} \} ,$$

wherein γ^{ij} and \hat{γ}^{ij} are derived by applying Farka's theorem to inequality conditions w′A^{j}λ^{j}−w′Aⁱλⁱ≦−1 on constraints λ^{j}, λⁱ, respectively, wherein

$$0 \leq {λ}^{i , j} \leq 1 , \sum {λ}^{i , j} = 1 ,$$

and K is an arbitrary kernel function.

According to a further aspect of the invention, the linear inequality constraints are equalities represented by

$${Q}_{ij} = \{ \begin{matrix}\begin{matrix}{γ}^{ij} + K ( {A}^{i} , {A}^{′} ) v + {y}^{i} = 0 , \\ {\hat{γ}}^{ij} - K ( {A}^{j} , {A}^{′} ) v + {y}^{j} = 0 ,\end{matrix} \\ {γ}^{ij} + {\hat{γ}}^{ij} = - 1.\end{matrix} \} ,$$

wherein vε [symbol] is a weighting of said slack terms, γ^{ij} and \hat{γ}^{ij} are derived by applying Farka's theorem to equality conditions w′A^{j}λ^{j}−w′Aⁱλⁱ=−1 on constraints λ^{j}, λⁱ, respectively, wherein 0≦λ^{i,j}≦1,

$$\sum {λ}^{i , j} = 1 ,$$

and K is an arbitrary kernel function, and wherein said mathematical program is of form

$${min}_{\{ v , {γ}^{ij} \vert ( i , j ) ∈ E \}} \frac{1}{2} {\sum }_{( i , j ) ∈ E} [ v \begin{matrix}( \begin{matrix}{‖ - {γ}^{ij} - K ( {A}^{i} , {A}^{′} ) v ‖}_{2}^{2} + \\ {‖ {\hat{γ}}^{ij} + K ( {A}^{j} , {A}^{′} ) v ‖}_{2}^{2} +\end{matrix} ) \\ μ {‖ {\hat{γ}}^{ij} + {γ}^{ij} + 1 ‖}_{2}^{2}\end{matrix} ] + {‖ v ‖}_{2}^{2}$$

wherien με [symbol] is a weighting of the equality constraints.

According to a further aspect of the invention, the method comprises solving said mathematical program by means of least squares.

According to a further aspect of the invention, μ is approximately one.

According to a further aspect of the invention, the number of sets is two, represented by A⁺ and A⁻, wherein A⁻ [symbol] A⁺, and wherein the ranking function satisfies the constraints

$${w}^{′} {A}^{′ -} {λ}^{-} - {w}^{′} {A}^{′ +} {λ}^{+} \leq - 1 , for all ( {λ}^{+} , {λ}^{-} ) such that \{ \begin{matrix}0 \leq {λ}^{+} \leq 1 , \sum {λ}^{+} = 1 \\ 0 \leq {λ}^{-} \leq 1 , \sum {λ}^{-} = 1\end{matrix} \} ,$$

wherein w is a vector in [symbol] ⁿ.

According to a further aspect of the invention, A⁺ and A⁻ are non-separable, and wherein the ranking function satisfies

w′A′⁻λ⁻−w′A′⁺λ⁺≦−1+(λ⁻y⁻+λ⁺y⁺), wherein y⁺, y⁻ are slack variables greater than or equal to zero.

According to a further aspect of the invention, the feature points represent tissue sample regions.

According to a further aspect of the invention, the method comprises using said ranking to determine a probability of said tissue sample being diseased.

According to a further aspect of the invention, the method comprises using said ranking to determine a malignancy of diseased tissue sample regions.

According to a further aspect of the invention, the tissue sample regions are derived from a plurality of patients, and further comprising using said ranking to sort said plurality of patients according to a predetermined criteria.

According to a further aspect of the invention, the ordering of at least some of said training data sets is provided by a physician.

According to a further aspect of the invention, the training samples are assigned to sets based on the results of a diagnostic test.

According to a further aspect of the invention, the training samples are assigned to sets by a physician.

According to a further aspect of the invention, the feature points are derived from a patient's electronic medical record.

According to another aspect of the invention, there is provided a program storage device readable by a computer, tangibly embodying a program of instructions executable by the computer to perform the method steps for finding a ranking function ƒ that classifies feature points in an n-dimensional space.

### BRIEF DESCRIPTION OF THE DRAWINGS

FIGS. 1(a)-(f) illustrate the types of graphs that can be incorporated into a ranking method according to an embodiment of the invention.

FIG. 2 depicts an exemplary non-separable binary problem, according to an embodiment of the invention.

FIG. 3 displays a list of nine publicly available datasets upon which a ranking method according to an embodiment of the invention was tested.

FIGS. 4(a)-(b) are graphs of the results of comparisons of current ranking algorithms and a ranking method according to an embodiment of the invention.

FIGS. 5(a)-(b) are graphs of summary results of an experimental evaluation for a least-squares formulation of a ranking method according to an embodiment of the invention.

FIG. 6 is a flow chart of a ranking method according to an embodiment of the invention.

FIG. 7 is a block diagram of an exemplary computer system for implementing a ranking method according to an embodiment of the invention.

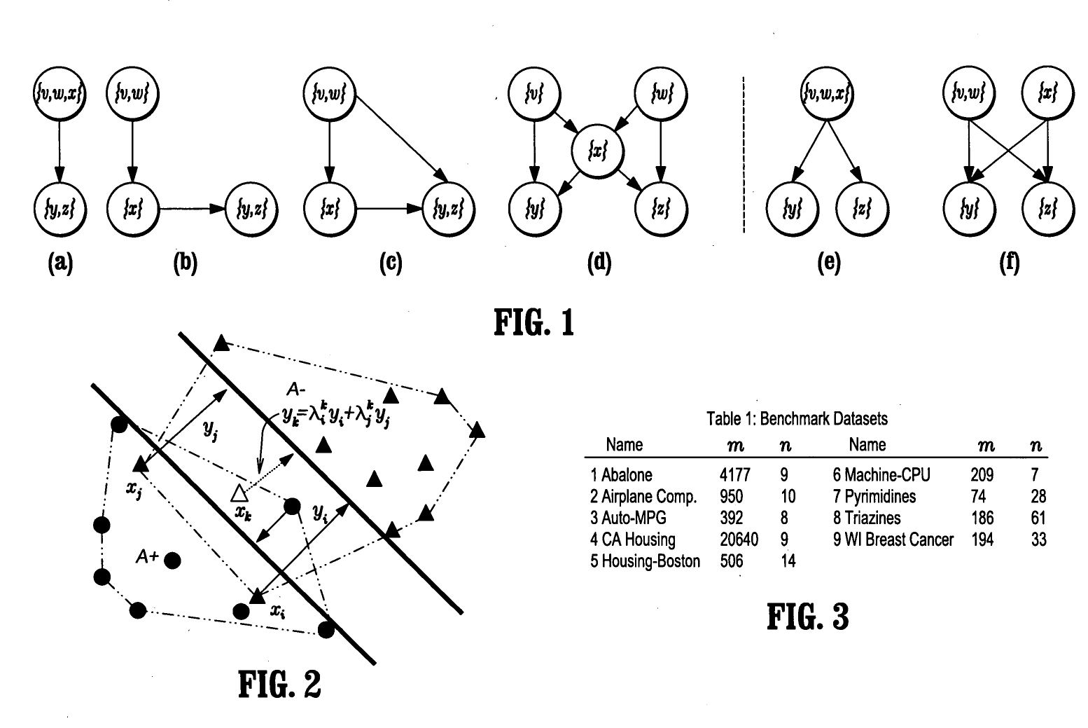

### DETAILED DESCRIPTION OF THE PREFERRED EMBODIMENTS

Exemplary embodiments of the invention as described herein generally include systems and methods for learning ranking functions from order constraints between sets or classes of training samples. Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention.

The following notation will be used herein below. Vectors will be assumed to be column vectors unless transposed to a row vector by a prime superscript ′. For a vector x in the n-dimensional real space [symbol] ⁿ, the cardinality of a set A will be denoted by |A|. The scalar (inner) product of two vectors x and y in the n-dimensional real space [symbol] ⁿ will be denoted by x′y and the 2-norm of x will be denoted by ∥x∥. For a matrix Aε [symbol] ^{m×n}, Aᵢε [symbol] ⁿ denotes a row vector formed by the elements of the i-th row of A. Similarly Aⱼε [symbol] ⁿ denotes a column vector formed by the elements of the j-th column of A. A column vector of ones of arbitrary dimension will be denoted by e. For Aε [symbol] ^{m×n} and Bε [symbol] ^{n×k}, the kernel K(A,B) maps [symbol] ^{m×n}× [symbol] ^{n×k} into [symbol] ^{m×k}. In particular, if column vectors in [symbol] ⁿ, then K(x′,y) is a real number, K(x′,A′) is a row vector in [symbol] ⁿ, and K(A,A′) is an m×m matrix. The identity matrix of arbitrary dimension will be denoted by I.

A distinction is usually made between classification and ordinal regression methods on one hand, and ranking on the other. In particular, the loss functions used for classification and ordinal regression evaluate whether each test sample is correctly classified: in other words, the loss functions that are used to evaluate these algorithms, such as the 0-1 loss for binary classification, are computed for every sample individually, and then averaged over the training or test set.

By contrast, bipartite ranking solutions are evaluated using the Wilcoxon-Mann-Whitney (WMW) statistic, which measures the (sample averaged) probability that any pair of samples is ordered correctly. Intuitively, the WMW statistic can be interpreted as the area under the ROC curve. According to an embodiment of the invention, a generalization of the WMW statistic is defined that accounts for class-ordering:

$$WMW ( f , A ) = {\sum }_{{E}_{ij}} \frac{{\sum }_{k = 1}^{{m}_{i}} {\sum }_{l = 1}^{{m}_{j}} {1}_{( f ( {x}_{i}^{k} ) < f ( {x}_{l}^{j} ) )}}{{\sum }_{k = 1}^{{m}_{i}} {\sum }_{l = 1}^{{m}_{j}} 1} .$$

Hence, if a sample is individually misclassified because it falls on the wrong side of the decision boundary between classes, it incurs a penalty in ordinal regression, whereas, in ranking, it may be possible that it is still correctly ordered with respect to every other test sample, and thus it will incur no penalty in the WMW statistic.
Convex Hull Formulation

A ranking method according to an embodiment of the invention learns a ranking function ƒ: [symbol] ⁿ→ [symbol] given known ranking relationships between some training instances Aⁱ,A^{j}⊂A (or A⁺ and A⁻ in the two class, binary case). Let the ranking relationships be specified by the set E={(i, j)|Aⁱ [symbol] A^{j}}. For ease of notation, the pairs (i, j) in the set E will be denoted Eᵢⱼ. Consider the linearly separable binary ranking case which is equivalent to classifying m points in the n-dimensional real space [symbol] ⁿ, represented by the m×n matrix A, according to membership of each point x=Aᵢ in the class A⁺ or A⁻ as specified by a given vector of labels d. For binary classifiers, this is equivalent to a linear ranking function ƒ_{w}(x)=w′x that satisfies the following constraints:
∀(x⁺εA⁺,x⁻εA⁻),ƒ(x⁻)≦ƒ(x⁺) [symbol] ƒ(x⁻)−ƒ(x⁺)=w′x⁻−w′x⁻−w′x⁺≦−1≦0. (1)

The number of constraints in equation (1) grows as O(m⁺m⁻), which is roughly quadratic in the number of training samples (unless there is a severe class imbalance). While additional insights permit this to be overcome in the separable case, in the non-separable case, the quadratic growth in the number of constraints poses computational burdens on any optimization algorithm, and direct optimization with these constraints is unfeasible even for moderate sized problems. This computational problem can be addressed based on three insights that are explained below.

First, notice that, by negation, the feasibility constraints in (1) can also be defined as:
∀(x⁺εA⁺,x⁻εA⁻),w′x⁻−w′x⁺≦−1 [symbol] (x⁺εA⁺,x⁻εA⁻),w′x⁻−w′x⁺>−1.
In other words, a solution w is feasible iff there exist no pair of samples from the two classes such that ƒ_{w}(·) orders them incorrectly.

Second, the constraints in (1) can be made more stringent: instead of requiring that equation (1) be satisfied for each possible pair (x⁺εA⁺,x⁻εA⁻) in the training set, require (1) to be satisfied for each pair (x⁺εconv(A⁺),x⁻εconv(A⁻)), where conv(Aⁱ) denotes the convex hull of the set Aⁱ. Thus, the constraints become:

$$∀ ( {λ}^{+} , {λ}^{-} ) such that \{ \begin{matrix}0 \leq {λ}^{+} \leq 1 , \sum {λ}^{+} = 1 \\ 0 \leq {λ}^{-} \leq 1 , \sum {λ}^{-} = 1\end{matrix} \} , {w}^{′} {A}^{- ′} {λ}^{′} - {w}^{′} {A}^{+ ′} {λ}^{′} \leq - 1. \qquad ( 2 )$$

Next, notice that all the linear inequality and equality constraints on (λ⁺, λ⁻) can be grouped together as Bλ[b, where,

$$λ = {[ \begin{matrix}{λ}^{-} \\ {λ}^{+}\end{matrix} ]}_{m \times 1} , {b}^{+} = {[ \begin{matrix}{0}_{{m}^{+} \times 1}^{+} \\ 1 \\ - 1\end{matrix} ]}_{( {m}^{+} + 2 ) \times 1} , {b}^{-} = {[ \begin{matrix}{0}_{{m}^{-} \times 1}^{-} \\ 1 \\ - 1\end{matrix} ]}_{( {m}^{-} + 2 ) \times 1} , b = [ \begin{matrix}{b}^{+} \\ {b}^{-}\end{matrix} ] , \\ {B}^{-} = {[ \begin{matrix}- {I}_{{m}^{-}} 0 \\ {ⅇ}^{′} 0 \\ - {ⅇ}^{′} 0\end{matrix} ]}_{( {m}^{-} + 2 ) \times m} , {B}^{+} = {[ \begin{matrix}0 - {I}_{{m}^{+}} \\ 0 {ⅇ}^{′} \\ 0 - {ⅇ}^{′}\end{matrix} ]}_{( {m}^{+} + 2 ) \times m} , B = [ \begin{matrix}{B}^{-} \\ {B}^{+}\end{matrix} ] .$$

Thus, the constraints on w can be written in the following equivalent forms:
∀λs.t. Bλ≦b, w′A⁻^{^{′}}λ⁻−w′A⁺^{^{′}}λ⁺≦−1, (3a) [symbol]
λs.t. B′λ≦b, w′A⁻^{^{′}}λ⁻−w′A⁺^{^{′}}λ⁺>−1, (3b) [symbol]
∃u s.t. B′u−w′[A⁻^{^{′}}−A⁺^{^{′}}]=0, b′u≦−1,u≧0, (3c)
where the second equivalent form of the constraints was obtained by negation (as before), and the third equivalent form results from the third insight: the application of Farka's theorem of alternatives. Farka's theorem states that for an x≧0 where Ax=b, there exists a z such that z′A≧0 and z′b<0. The use of Farka's theorem allows one to incorporate logical conditions into a set of equations. In the situation above, the logical condition is of the form: IF Bλ≦b THEN w′A⁻^{^{′}}λ⁻−w′A⁺^{^{′}}λ⁺≦−1, while (3c) is the resulting equations. The application of Farka's theorem is referred to herein as a Farka transformation. Note that the resulting equations can be inequalities. The resulting linear system of m equalities and m+5 inequalities in m+n+4 variables can be used while minimizing any regularizer (such as ∥w∥²) to obtain the linear ranking function that satisfies equation (1). Note that this formulation avoids the O(m²) scaling in constraints.
Binary Non-Separable Case

In a binary non-separable case, conv(A⁺)∩conv(A⁻)≠∅, so the requirements should be relaxed by introducing slack variables. One slack variable yᵢ≧0 can be introduced for each training sample xᵢ, and the slack for any point inside the convex hull conv(A^{j}) can be expressed as a convex combination of the yᵢ's. This implies that if only a subset of training samples has non-zero slacks yᵢ>0, (i.e. they are possibly misclassified), then the slacks of any points inside the convex hull also only depend on those yᵢ. Thus, the constraints now become:
∀λs.t. Bλ≦b, w′A⁻^{^{′}}λ⁻−w′A⁺^{^{′}}λ⁺≦−1+(λ⁻y⁻+λ⁺y⁺), y⁺,y⁻≧0.
Applying Farka's theorem of alternatives, one finds that equation (2) is equivalent to:

$$∃ u s . t . {B}^{′} u - [ \begin{matrix}{A}^{-} w \\ - {A}^{+} w\end{matrix} ] + [ \begin{matrix}{y}^{-} \\ {y}^{+}\end{matrix} ] = 0 , {b}^{′} u \leq - 1 , u \geq 0 \qquad ( 3 )$$

Replacing B from the above definitions and defining u′=[(u⁻)^{′}(u⁺)^{′}]≧0, the following constraints are obtained:
(Bⁱ)^{′}u⁺+A⁺w+y⁺=0,
(Bⁱ)^{′}u⁻−A⁻w+y⁻=0,
b⁺u⁺+b⁻u⁻≦−1,u≧0.

FIG. 2 depicts an exemplary non-separable binary problem, according to an embodiment of the invention. Referring to the figure, points belonging to the A+ and A⁻ sets are represented by circles and triangles, respectively. Two elements xᵢ and xⱼ of the set A⁻ are not correctly ordered and hence generate positive values of the corresponding slack variables yᵢ and yⱼ. On the other hand, element xₖ, represented by a hollow triangle, is in the convex hull of the set A⁻ and hence the corresponding yₖ error can be written as a convex combination yₖ=λᵢ^{k}yᵢ+λⱼ^{k}yⱼ of the two nonzero errors corresponding to points of A⁻.

The General Ranking Case

The three insights presented above can be applied to any arbitrary directed order graph G=(S, E), each of whose vertices corresponds to a class A^{j} and where the existence of a directed edge Eᵢⱼ means that all training samples xᵢεAⁱ should be ranked higher than any sample xⱼεA^{j}:
ƒ(x^{j})≦ƒ(xⁱ) [symbol] ƒ(x^{j})−ƒ(xⁱ)=w′x^{j}−w′xⁱ≦−1≦0.
Analogously, the following set of equations that enforces the ordering between sets Aⁱ and A^{j} can be obtained:
(Bⁱ)^{′}u^{ij}+Aⁱw+yⁱ=0,
(B^{j})^{′}û^{ij}−A^{j}w+y^{j}=0,
bⁱu^{ij}+b^{j}û^{ij}≦−1,
u^{ij},û^{ij}≦0. (4)
Furthermore, using the definitions of Bⁱ, B^{j}, bⁱ, b^{j} and the fact that u^{ij},û^{ij}≧0, the constraints of equations (4) can be rewritten in the following way:
eγ^{ij}+Aⁱw+yⁱ≧0,
e\hat{γ}^{ij}−A^{j}w+y^{j}≧0,
γ^{ij}+\hat{γ}^{ij}≦−1,
yⁱ,y^{j}≧0. (5)
where γ^{ij}=bⁱu^{ij} and \hat{γ}^{ij}=b^{j}û^{ij}. Note that enforcing the constraints defined above implies a desired ordering:
Aⁱw+yⁱ≧−eγ^{ij}≧e\hat{γ}^{ij}+1≧e\hat{γ}^{ij}≧A^{j}w−y^{j}.
To obtain a more general nonlinear algorithm, equations (4) can be “kernelized” by making a transformation of the variable w as: w=A′v, where v can be interpreted as an arbitrary variable in [symbol] ^{m}. Employing this transformation, equations (4) become:
eγ^{ij}+AⁱA′v+yⁱ≧0,
e\hat{γ}^{ij}−A^{j}A′v+y^{j}≧0,
γ^{ij}+\hat{γ}^{ij}≦−1,
yⁱ,y^{j}≧0
If the linear kernels AⁱA′ and A^{j}A′ are replaced by more general kernels K(Aⁱ,A′) and K(A^{j}, A′), a “kernelized” version of equations (4) is obtained:

$${Q}_{ij} = \{ \begin{matrix}e {γ}^{ij} + K ( {A}^{i} , {A}^{′} ) v + {y}^{i} \geq 0 \\ e {\hat{γ}}^{ij} - K ( {A}^{j} , {A}^{′} ) v + {y}^{j} \geq 0 \\ {γ}^{ij} + {\hat{γ}}^{ij} \leq - 1 \\ {y}^{i} , {y}^{j} \geq 0\end{matrix} \} . \qquad ( 5 )$$

Given a graph G=(S, E) representing the ordering of the training data and using equations (5), a general mathematical programming formulation for ranking can be presented:

$$\begin{matrix}{min}_{\{ v , {y}^{i} , {γ}^{ij} \vert ( i , j ) ∈ E \}} v ɛ ( y ) + R ( v ) & s . t . {Q}_{ij} & ∀ ( i , j ) ∈ E .\end{matrix} \qquad ( 6 )$$

In equation (6), ε is a loss function for the slack variables yⁱ and R(v) represents a regularizer on the normal to the hyperplane v. For an arbitrary kernel K(x,x′), the number of variables in formulation (6) is 2m+2|E|, and the number of linear equations (excluding the non-negativity constraints) is m|E|+|E|=|E|(m+1). For a linear kernel, K(x,x′)=xx′, the number of variables of formulation (6) becomes m+n+2|E|, and the number of linear equations remains the same. When using a linear kernel and using ε(x)=R(x)=∥x∥², the optimization formulation (6) becomes a linearly constrained quadratic optimization system for which a unique solution exists due to the convexity of the objective function:

$${min}_{\{ w , {y}^{i} , {γ}^{ij} \vert ( i , j ) ∈ E \}} v {‖ y ‖}^{2} + \frac{1}{2} {w}^{′} w \qquad s . t . \qquad {Q}_{ij} \qquad ∀ ( i , j ) ∈ E .$$

Unlike SVM-like methods for ranking that need O(m²) slack variables, a formulation according to an embodiment of the invention only requires one slack variable for each example, and only m slack variables are used, giving this formulation a computational advantage over other ranking methods.
Least-Squares Formulation

A least squares solution to ranking equations can be formulated by relaxing the inequalities of (6) in the following way:

$${Q}_{ij} = \{ \begin{matrix}e {γ}^{ij} + K ( {A}^{i} , {A}^{′} ) v + {y}^{i} \geq 0 \\ e {\hat{γ}}^{ij} - K ( {A}^{j} , {A}^{′} ) v + {y}^{j} \geq 0 \\ {γ}^{ij} + {\hat{γ}}^{ij} \leq - 1\end{matrix} \} \qquad ( 7 )$$

Given a graph G=(V, E) representing the ordering of the training data and using the “relaxed” constraints (7), the following unconstrained strongly convex quadratic programming formulation can be obtained for the ranking equations:

$${min}_{\{ v , {γ}^{ij} \vert ( i , j ) ∈ E \}} {\sum }_{( i , j ) ∈ E} [ v ( {‖ - e {γ}^{ij} - K ( {A}^{i} , {A}^{′} ) v ‖}_{2}^{2} + {‖ e {\hat{γ}}^{ij} - K ( {A}^{j} , {A}^{′} ) v ‖}_{2}^{2} ) + μ {‖ {\hat{γ}}^{ij} + {γ}^{ij} + 1 ‖}_{2}^{2} ] + {‖ v ‖}_{2}^{2} \qquad ( 8 )$$

where vε [symbol] and με [symbol] are regularization parameters that are selected by cross-validation on the training data. However, according to one embodiment of the invention m, a value of μ=1 works well, wherein in experiments testing the formulation only the v parameter need be tuned. To find the unique minimizer of formulation (8), one solves for the gradient of the objective function to be equal to zero, obtaining the following system of linear equations:

$${\sum }_{( i , j ) ∈ E}^{} v [ {( ⅇ {γ}^{ij} + K ( {A}^{i} , {A}^{′} ) v )}^{′} K ( {A}^{i} , {A}^{′} ) + {( - ⅇ {\hat{γ}}^{ij} + K ( {A}^{j} , {A}^{′} ) v )}^{′} K ( {A}^{j} , {A}^{′} ) ] + {v}^{′} = 0 , \\ v ( ⅇ {γ}^{ij} + K ( {A}^{i} , {A}^{′} ) v ) e + μ ( {\hat{γ}}^{ij} + {γ}^{ij} + 1 ) = 0 , \\ ∀ ( i , j ) ∈ E .$$

When using a linear kernel, e.g. K(x, y)=x′y, w=A′v, the linear system of equations to solve becomes:

$${\sum }_{( i , j ) ∈ E}^{} v [ {( {ⅇγ}^{ij} + {A}^{i} w )}^{′} {A}^{i} + {( - {ⅇγ}^{ij} + {A}^{j} w )}^{′} {A}^{j} ] + {w}^{′} = 0$$

$${v ( {ⅇγ}^{ij} + {A}^{i} w )}^{′} e + μ ( {γ}^{ij} + {γ}^{ij} + 1 ) = 0 , \\ ∀ ( i , j ) ∈ E .$$

Geometrically, when G is a chain graph, a hyperplane can be found that fits every class Aⁱ in the least square sense while simultaneously maximizing the margins between the classes.

According to an embodiment of the invention, the resulting square linear system of equations is of the size n+2|(E)|, where n is the number of features, usually a relatively small number (in the low hundreds) for most real-life applications. As a result, this least-squares formulation yields another order-of-magnitude improvement in the run-time of a ranking algorithm according to an embodiment of the invention.

### EXPERIMENTAL EVALUATION

A ranking method according to an embodiment of the invention was tested on a set of nine publicly available datasets shown in the table of FIG. 3. These datasets have been frequently used as a benchmark for ordinal regression methods. Here they are used for evaluating ranking performance. A method according to an embodiment of the invention is tested against SVM for ranking and an efficient Gaussian process method (the informative vector machine (IVM)).

Since these datasets were originally designed for testing regression, the continuous target values for each dataset were discretized into five equal size bins. These bins were used to define ranking constraints: all the datapoints with target values falling in the same bin were grouped together. Each dataset was divided into 10% for testing and 90% for training, in a 10-fold cross validation schedule. Thus, for all of the algorithms tested, the input was, for each point in the training set: (1) a vector in [symbol] ⁿ, where n is different for each set; and (2) a value from 1 to 5 denoting the rank of the group to which it belongs.

Accuracy of these algorithms is defined in terms of the Wilcoxon statistic for ordinal regression. Since information about the ranking of the elements within each group is not used, order constraints within a group cannot be verified. The total number of order constraints for ordinal regression is equal to

$$( \begin{matrix}m \\ 2\end{matrix} ) - {\sum }_{i} ( \begin{matrix}{m}_{i} \\ 2\end{matrix} ) ,$$

where mᵢ is the number of instances in group i.

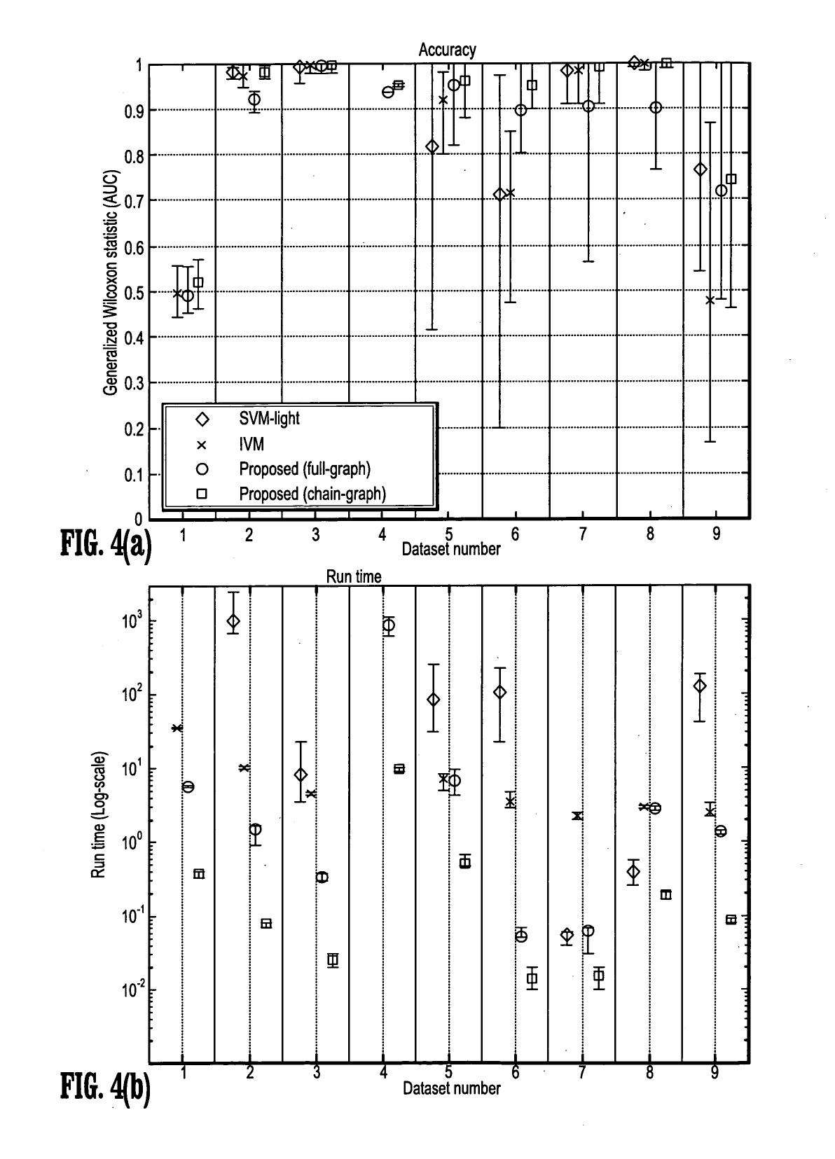

The results for all methods tested are shown in FIG. 4. A formulation according to an embodiment of the invention was tested employing two different order graphs: the full directed acyclic graph and the chain graph. For each dataset, the accuracy of a method according to an embodiment of the invention is either comparable to or better than current methods, when using a chain order graph. Regarding run-time performance, an algorithm according to an embodiment of the invention can be up to at least an order of magnitude faster than current implementations of state-of-the-art methods.

FIGS. 4(a)-(b) are graphs of the results of comparisons of current ranking algorithms and a ranking method according to an embodiment of the invention. FIG. 4(a) displays accuracy results, measured using the generalized Wilcoxon statistic, while FIG. 4(b) displays run-time performance results. The datasets tested were those listed in the table of FIG. 3. Along with the mean values in 10 fold cross-validation, the entire range of variation is indicated in the error-bars. Referring to FIG. 4(a), the overall accuracy for all the three methods is comparable. Referring to FIG. 4(b), a method according to an embodiment of the invention has a lower run time than the other methods, even for the full graph case for medium to large size datasets.

Note, however, that the accuracy of a method according to an embodiment of the invention when using a full graph is lower than that for a chain graph. Since the evaluation of accuracy was performed using the extended Wilcoxon statistic for ordinal regression, which inherently reflects the chain graph in terms of the ordering of the classes, this observation is not entirely surprising. Nevertheless, it is interesting that enforcing more order constraints does not necessarily imply higher accuracy. This may be due to the role that the slack variables play in both formulations, since the number of slack variables remains the same while the number of constraints increases. Adding more slack variables may positively affect performance in the full graph, but this comes at a computational cost.

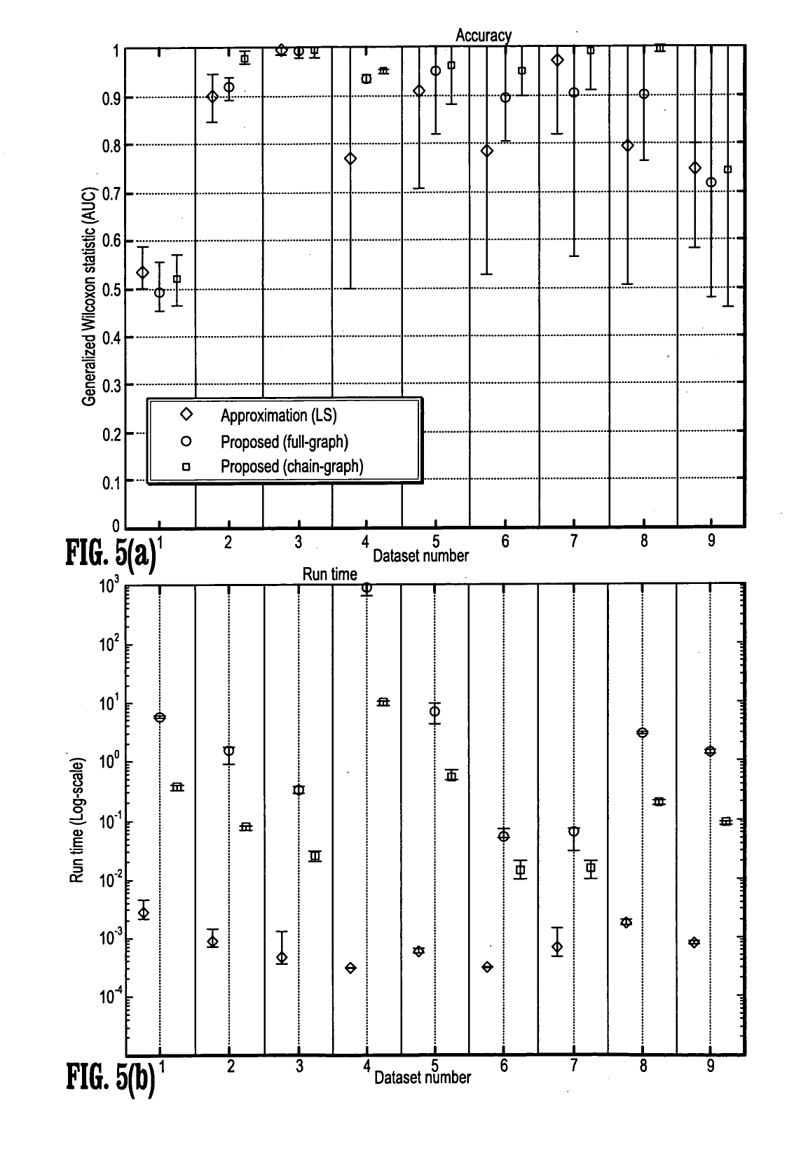

A least squares approximation according to an embodiment of the invention was tested for a chain graph using the same publicly available datasets, and the same experimental setup as above, in a 10-fold cross validation. Results are shown in FIG. 5. On average, the approximate method is less accurate as compared to the original one. However, accuracy is still comparable with other current methods. Run-time performance is is about an order of magnitude faster than the original formulation for the chain graph.

FIGS. 5(a)-(b) are graphs of summary results of an experimental evaluation for a least-squares formulation of a ranking method according to an embodiment of the invention. FIG. 5(a) displays accuracy results, measured using the generalized Wilcoxon statistic, while FIG. 5(b) displays run-time performance results. The datasets tested were those listed in the table of FIG. 3. The graphs show mean values and entire range of variation, as indicated by the error-bars, in a 10 fold cross validation. The results are for the least squares approximation vs. the basic ranking formulation, according to embodiments of the invention, using the two types of order graphs tested in the previous experiment. Referring to FIG. 5(a), overall accuracy of the least squares method is comparable with that of competing methods, as depicted in FIGS. 4, and slightly worse than that of a basic ranking formulation according to an embodiment of the invention. Referring to FIG. 5(b), in terms of run-time, a least squares formulation is several orders of magnitude faster than the fastest method tested, including a basic formulation according to an embodiment of the invention.

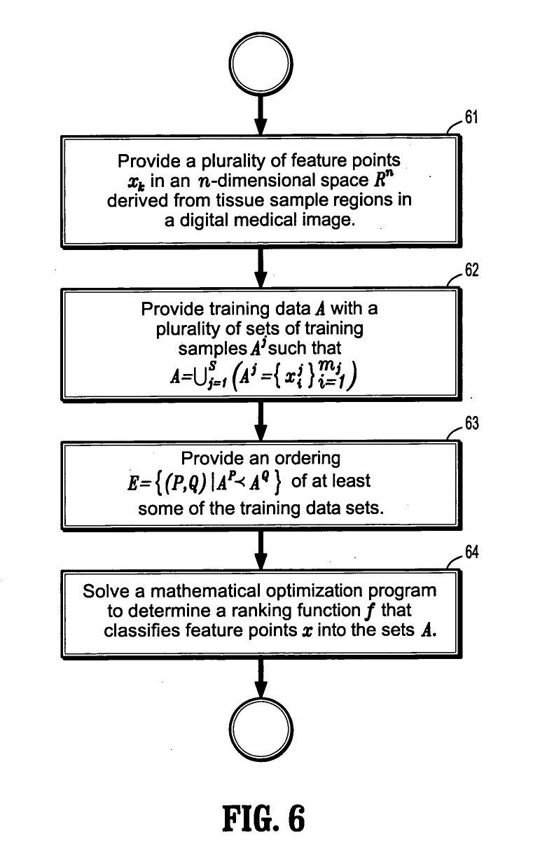

A flow chart of a ranking method according to an embodiment of the invention is depicted in FIG. 6. Referring now to the figure, a plurality of feature points xₖ in an n-dimensional space Rⁿ is provided in step 61. The feature points can derived from tissue sample regions in a digital medical image. Alternatively, the feature points could be obtained from a patient's electronic medical record, or could represent individual patients for the purpose of sorting patients by a severity of disease. A training data A that includes a plurality of sets of training samples A^{j} is provided at step 62, where

$$A = {⋃}_{j = 1}^{S} ( {A}^{j} = {\{ {x}_{i}^{j} \}}_{i = 1}^{{m}_{j}} ) ,$$

where S is the number of sets and the j^{th} set A^{j} includes my samples xᵢ^{j}. At step 63, an ordering E={(P,Q)|A^{P} [symbol] A^{Q}} of at least some of the training data sets is provided, where E_{PQ} signifies that all training samples xᵢεA^{P} are ranked higher than any sample xⱼεA_{Q}. A mathematical optimization program is solved at step 64 to determine the ranking function ƒ that classifies the feature points x into the sets A, where for any two sets Aⁱ, A^{j}, one has Aⁱ [symbol] A^{j}. The ranking function ƒ satisfies inequality constraints ƒ(xᵢ)≦ƒ(xⱼ) for all xᵢεconv(Aⁱ) and xⱼεconv(A^{j}), where conv(A) represents the convex hull of the elements of set A. The ranking can represent categorizing the probability of or status of a disease, for example, ranking cancer lesions as [1] definitely malignant, [2] likely malignant, [3] not sure, [4] likely benign, [5] definitely benign, or other disease status categories, or ranking sample regions in order of the probability of the region being diseased.
Hardware Support

It is to be understood that the present invention can be implemented in various forms of hardware, software, firmware, special purpose processes, or a combination thereof. In one embodiment, the present invention can be implemented in software as an application program tangible embodied on a computer readable program storage device. The application program can be uploaded to, and executed by, a machine comprising any suitable architecture.

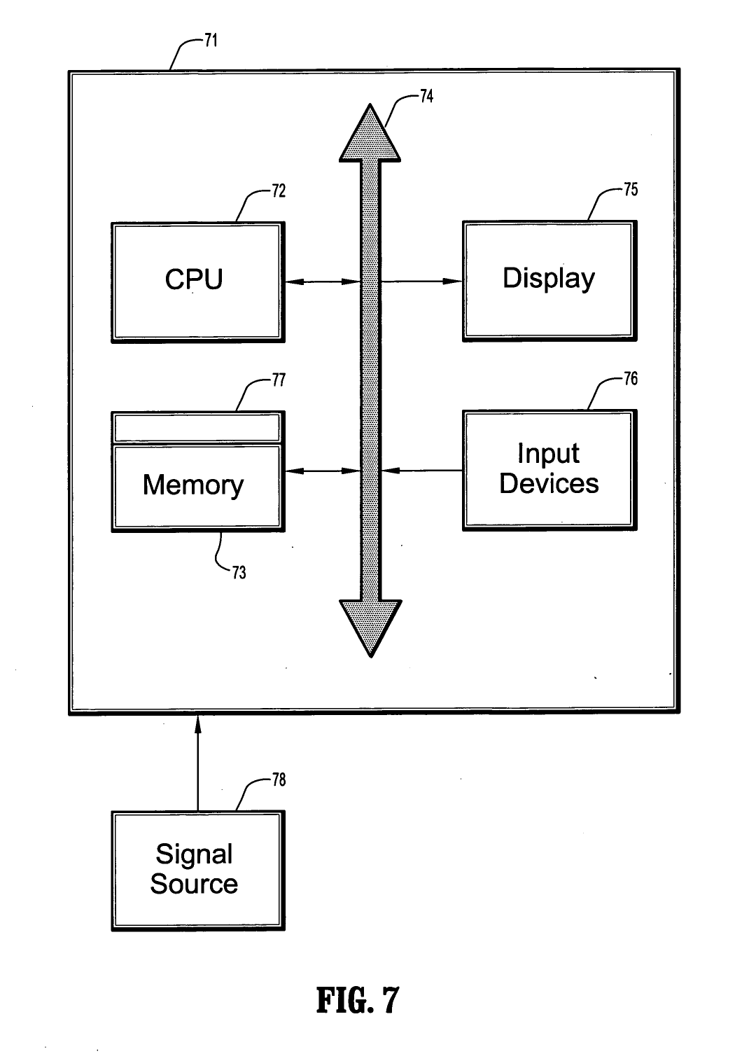

FIG. 7 is a block diagram of an exemplary computer system for implementing a ranking method according to an embodiment of the invention. Referring now to FIG. 7, a computer system 71 for implementing the present invention can comprise, inter alia, a central processing unit (CPU) 72, a memory 73 and an input/output (I/O) interface 74. The computer system 71 is generally coupled through the I/O interface 74 to a display 75 and various input devices 76 such as a mouse and a keyboard. The support circuits can include circuits such as cache, power supplies, clock circuits, and a communication bus. The memory 73 can include random access memory (RAM), read only memory (ROM), disk drive, tape drive, etc., or a combinations thereof. The present invention can be implemented as a routine 77 that is stored in memory 73 and executed by the CPU 72 to process the signal from the signal source 78. As such, the computer system 71 is a general purpose computer system that becomes a specific purpose computer system when executing the routine 77 of the present invention.

The computer system 71 also includes an operating system and micro instruction code. The various processes and functions described herein can either be part of the micro instruction code or part of the application program (or combination thereof) which is executed via the operating system. In addition, various other peripheral devices can be connected to the computer platform such as an additional data storage device and a printing device.

It is to be further understood that, because some of the constituent system components and method steps depicted in the accompanying figures can be implemented in software, the actual connections between the systems components (or the process steps) may differ depending upon the manner in which the present invention is programmed. Given the teachings of the present invention provided herein, one of ordinary skill in the related art will be able to contemplate these and similar implementations or configurations of the present invention.

While the present invention has been described in detail with reference to a preferred embodiment, those skilled in the art will appreciate that various modifications and substitutions can be made thereto without departing from the spirit and scope of the invention as set forth in the appended claims.

What is claimed is:

1. A method for finding a ranking function ƒ that classifies feature points in an n-dimensional space, said method comprising the steps of:
providing a plurality of feature points xₖ in an n-dimensional space Rⁿ, said feature points derived from a digital medical image;
providing training data A comprising a plurality of sets of training samples A^{j} wherein
$$A = {⋃}_{j = 1}^{S} ( {A}^{j} = {\{ {x}_{i}^{j} \}}_{i = 1}^{{m}_{j}} ) ,$$
wherein S is a number of sets and a j^{th} set A^{j} includes mⱼ samples xᵢ^{j};
providing an ordering E={(P,Q)|A^{P} [symbol] A^{Q}} of at least some of said training data sets wherein all training samples xᵢεA^{P} are ranked higher than any sample xⱼεA^{Q};
solving a mathematical optimization program to determine said ranking function ƒ that classifies said feature points x into said plurality of sets A, wherein for any two sets Aⁱ, A^{j}, wherein Aⁱ [symbol] A^{j}, the ranking function ƒ satisfies inequality constraints ƒ(xᵢ)≦ƒ(xⱼ) for all xᵢεconv(Aⁱ) and xᵢεconv(A^{j}), wherein conv(A) represents the convex hull of the elements of set A.

2. The method of claim 1, wherein the ranking function is a linear function of the feature points x of the form w′x, wherein w is an n-dimensional vector.

3. The method of claim 2, wherein said mathematical optimization program includes slack variables y greater or equal to zero for non-separable sets wherein not all inequality constraints can be satisfied, wherein said slack variables are a measure of the extent to which constraints are violated in said mathematical program.

4. The method of claim 3, comprising one slack variable yⁱ for each of said training samples xᵢ, wherein any training sample point inside the convex hull of any set is associated with a slack variable equal to a convex combination of yⁱ with coefficients λ.

5. The method of claim 4, wherein said mathematical program is of form
$${min}_{\{ w , {y}^{i} , {γ}^{ij} \vert ( i , j ) ∈ E \}} v {‖ y ‖}^{2} + \frac{1}{2} {w}^{′} w$$
such that the equation set Qᵢⱼ is satisfied ∀(i, j)εE, wherein w is an n-dimensional vector, v is real number controlling the trade off between the two terms, equation set Qᵢⱼ is
$${Q}_{ij} ≡ \{ \begin{matrix}{γ}^{ij} + K ( {A}^{i} , {A}^{′} ) v + {y}^{i} \geq 0 \\ {\hat{γ}}^{ij} - K ( {A}^{j} , {A}^{′} ) v + {y}^{j} \geq 0 \\ {γ}^{ij} + {\hat{γ}}^{ij} \leq - 1 \\ {y}^{i} , {y}^{j} \geq 0\end{matrix} \} ,$$
wherein γ^{ij} and \hat{γ}^{ij} are derived by applying Farka's theorem to inequality conditions w′A^{j}λⁱ−w′Aⁱλⁱ≦−1 on constraints λ^{j}, λⁱ, respectively, wherein 0≦λ^{i,j}≦1,
$$\sum {λ}^{i , j} = 1 ,$$
and K is an arbitrary kernel function.

6. The method of claim 4, wherein said linear inequality constraints are equalities represented by
$${Q}_{ij} = \{ \begin{matrix}{γ}^{ij} + K ( {A}^{i} , {A}^{′} ) v + {y}^{i} = 0 , \\ {\hat{γ}}^{ij} - K ( {A}^{j} , {A}^{′} ) v + {y}^{j} = 0 , \\ {γ}^{ij} + {\hat{γ}}^{ij} = - 1.\end{matrix} \} ,$$
wherein vε [symbol] is a weighting of said slack terms, γ^{ij} and \hat{γ}^{ij} are derived by applying Farka's theorem to equality conditions w′A^{j}λ^{j}−w′Aⁱλⁱ=−1 on constraints λ^{j}, λⁱ, respectively, wherein 0≦λ^{i,j}≦1,
$$\sum {λ}^{i , j} = 1 ,$$
and K is an arbitrary kernel function, and wherein said mathematical program is of form
$${min}_{\{ v , {γ}^{ⅈj} \vert ( i , j ) ∈ E \}} \frac{1}{2} {\sum }_{( i , j ) ∈ E}^{} [ v ( {‖ - {γ}^{ⅈj} - K ( {A}^{i} , {A}^{′} ) v ‖}_{2}^{2} + {‖ {\hat{γ}}^{ⅈj} + K ( {A}^{j} , {A}^{′} ) v ‖}_{2}^{2} ) + μ {‖ {\hat{γ}}^{ⅈj} + {γ}^{ⅈj} + 1 ‖}_{2}^{2} ] + {‖ v ‖}_{2}^{2}$$
wherien με [symbol] is a weighting of the equality constraints.

7. The method of claim 6, further comprising solving said mathematical program by means of least squares.

8. The method of claim 6, wherein μ is approximately one.

9. The method of claim 1, wherein the number of sets is two, represented by A⁺ and A⁻, wherein A⁻ [symbol] A⁺, and wherein the ranking function satisfies the constraints
$${w}^{′} {A}^{′ -} {λ}^{-} - {w}^{′} {A}^{′ +} {λ}^{+} \leq - 1 , for all ( {λ}^{+} , {λ}^{-} ) such that \{ \begin{matrix}0 \leq {λ}^{+} \leq 1 , \sum {λ}^{+} = 1 \\ 0 \leq {λ}^{-} \leq 1 , \sum {λ}^{-} = 1\end{matrix} \} ,$$
wherein w is a vector in [symbol] ⁿ.

10. The method of claim 9, wherein A⁺ and A⁻ are non-separable, and wherein the ranking function satisfies
w′A′⁻λ⁻−w′A′⁺λ⁺≦−1+(λ⁻y⁻+λ⁻+λ⁺y⁺), wherein y⁺, y⁻ are slack variables greater than or equal to zero.

11. The method of claim 1, wherein said feature points represent tissue sample regions.

12. The method of claim 11, further comprising using said ranking to determine a probability of said tissue sample being diseased.

13. The method of claim 11, further comprising using said ranking to determine a malignancy of diseased tissue sample regions.

14. The method of claim 11, wherein said tissue sample regions are derived from a plurality of patients, and further comprising using said ranking to sort said plurality of patients according to a predetermined criteria.

15. The method of claim 1, wherein said ordering of at least some of said training data sets is provided by a physician.

16. The method of claim 1, wherein said training samples are assigned to sets based on the results of a diagnostic test.

17. The method of claim 1, wherein said training samples are assigned to sets by a physician.

18. The method of claim 1, wherein said feature points are derived from a patient's electronic medical record.

19. A program storage device readable by a computer, tangibly embodying a program of instructions executable by the computer to perform the method steps for finding a ranking function ƒ that classifies feature points in an n-dimensional space, said method comprising the steps of:
providing a plurality of feature points xₖ in an n-dimensional space Rⁿ, said feature points derived from a digital medical image;
providing training data A comprising a plurality of sets of training samples A^{j} wherein
$$A = {⋃}_{j = 1}^{S} ( {A}^{j} = {\{ {x}_{i}^{j} \}}_{i = 1}^{{m}_{j}} ) ,$$
wherein S is a number of sets and a j^{th} set A^{j} includes mⱼ samples xᵢ^{j};
providing an ordering E={(P,Q)|A^{P} [symbol] A^{Q}} of at least some of said training data sets wherein all training samples xᵢεA^{P} are ranked higher than any sample xⱼεA^{Q};
solving a mathematical optimization program to determine said ranking function ƒ that classifies said feature points x into said plurality of sets A, wherein for any two sets Aⁱ, A^{j}, wherein Aⁱ [symbol] A^{j}, the ranking function ƒ satisfies inequality constraints ƒ(x₁)≦ƒ(xⱼ) for all xᵢεconv(Aⁱ) and xⱼεconv(A^{j}), wherein conv(A) represents the convex hull of the elements of set A.

20. The computer readable program storage device of claim 19, wherein the ranking function is a linear function of the feature points x of the form w′x, wherein w is an n-dimensional vector.

21. The computer readable program storage device of claim 20, wherein said mathematical optimization program includes slack variables y greater or equal to zero for non-separable sets wherein not all inequality constraints can be satisfied, wherein said slack variables are a measure of the extent to which constraints are violated in said mathematical program.

22. The computer readable program storage device of claim 21, comprising one slack variable yⁱ for each of said training samples xᵢ, wherein any training sample point inside the convex hull of any set is associated with a slack variable equal to a convex combination of yⁱ with coefficients λ.

23. The computer readable program storage device of claim 22, wherein said mathematical program is of form
$${min}_{\{ w , {y}^{i} , {γ}^{i j} \vert ( i , j ) ∈ E \}} v {‖ y ‖}^{2} + \frac{1}{2} {w}^{′} w$$
such that the equation set Qᵢⱼ is satisfied ∀(i, j)εE, wherein w is an n-dimensional vector, v is real number controlling the trade off between the two terms, equation set Qᵢⱼ is
$${Q}_{ij} ≡ \{ \begin{matrix}{γ}^{ⅈj} + K ( {A}^{i} , {A}^{′} ) v + {y}^{i} \geq 0 \\ {\hat{γ}}^{ⅈj} - K ( {A}^{j} , {A}^{′} ) v + {y}^{j} \geq 0 \\ {γ}^{ⅈj} + {\hat{γ}}^{ⅈj} \leq - 1 \\ {y}^{i} , {y}^{j} \geq 0\end{matrix} \} ,$$
wherein γ^{ij} and \hat{γ}^{ij} are derived by applying Farka's theorem to inequality conditions w′A^{j}λ^{j}−w′Aⁱλⁱ≦−1 on constraints λ^{j}, λⁱ, respectively, wherein 0≦λ^{i,j}≦1,
$$\sum {λ}^{ⅈ , j} = 1 ,$$
and K is an arbitrary kernel function.

24. The computer readable program storage device of claim 22, wherein said linear inequality constraints are equalities represented by
$${Q}_{ij} = \{ \begin{matrix}{γ}^{ⅈj} + K ( {A}^{i} , {A}^{′} ) v + {y}^{i} = 0 , \\ {\hat{γ}}^{ⅈj} - K ( {A}^{j} , {A}^{′} ) v + {y}^{j} = 0 , \\ {γ}^{ⅈj} + {\hat{γ}}^{ⅈj} = - 1.\end{matrix} \} .$$
wherein vε [symbol] is a weighting of said slack terms, γ^{ij} and \hat{γ}^{ij} are derived by applying Farka's theorem to equality conditions w′A^{j}λ^{j}−w′Aⁱλⁱ=−1 on constraints λ^{j}, λⁱ, respectively, wherein 0≦λ^{i,j}≦1,
$$\sum {λ}^{ⅈ , j} = 1 ,$$
and K is an arbitrary kernel function, and wherein said mathematical program is of form
$${min}_{\{ v , {γ}^{ⅈj} \vert ( i , j ) ∈ E \}} \frac{1}{2} {\sum }_{( i , j ) ∈ E}^{} [ v ( {‖ - {γ}^{ⅈj} - K ( {A}^{i} , {A}^{′} ) v ‖}_{2}^{2} + {‖ {\hat{γ}}^{ⅈj} + K ( {A}^{j} , {A}^{′} ) v ‖}_{2}^{2} ) + μ {‖ {\hat{γ}}^{ⅈj} + {γ}^{ⅈj} + 1 ‖}_{2}^{2} ] + {‖ v ‖}_{2}^{2}$$
wherein με [symbol] is a weighting of the equality constraints.

25. The computer readable program storage device of claim 24, the method further comprising solving said mathematical program by means of least squares.

26. The computer readable program storage device of claim 24, wherein μ is approximately one.

27. The computer readable program storage device of claim 19, wherein the number of sets is two, represented by A⁺ and A⁻, wherein A⁻ [symbol] A⁺, and wherein the ranking function satisfies the constraints
$${w}^{′} {A}^{′ -} {λ}^{-} - {w}^{′} {A}^{′ +} {λ}^{+} \leq - 1 , for all ( {λ}^{+} , {λ}^{-} ) such that \{ \begin{matrix}0 \leq {λ}^{+} \leq 1 , \sum {λ}^{+} = 1 \\ 0 \leq {λ}^{-} \leq 1 , \sum {λ}^{-} = 1\end{matrix} \} ,$$
wherein w is a vector in [symbol] ⁿ.

28. The computer readable program storage device of claim 27, wherein A⁺ and A⁻ are non-separable, and wherein the ranking function satisfies
w′A′⁻λ⁻−w′A′⁺λ⁺≦−1+(λ⁻y⁻+λ⁺y⁺), wherein y⁺, y⁻ are slack variables greater than or equal to zero.

29. The computer readable program storage device of claim 19, wherein said feature points represent tissue sample regions.

30. The computer readable program storage device of claim 29, the method further comprising using said ranking to determine a probability of said tissue sample being diseased.

31. The computer readable program storage device of claim 29, the method further comprising using said ranking to determine a malignancy of diseased tissue sample regions.

32. The computer readable program storage device of claim 29, wherein said tissue sample regions are derived from a plurality of patients, and further comprising using said ranking to sort said plurality of patients according to a predetermined criteria.

33. The computer readable program storage device of claim 19, wherein said ordering of at least some of said training data sets is provided by a physician.

34. The computer readable program storage device of claim 19, wherein said training samples are assigned to sets based on the results of a diagnostic test.

35. The computer readable program storage device of claim 19, wherein said feature points are derived from a patient's electronic medical record.

36. The computer readable program storage device of claim 19, wherein said training samples are assigned to sets by a physician.

37. A method for finding a ranking function ƒ that classifies feature points in an n-dimensional space, said feature points derived from a digital medical image wherein said feature points represent tissue sample regions, said method comprising the steps of:
providing a plurality of feature points xₖ in an n-dimensional space Rⁿ;
providing training data A comprising a plurality of sets of training samples A^{j} wherein
$$A = {⋃}_{j = 1}^{S} ( {A}^{j} = {\{ {x}_{i}^{j} \}}_{i = 1}^{{m}_{j}} ) ,$$
wherein S is a number of sets and a j^{th} set A^{j} includes mⱼ samples xᵢ^{j};
solving a mathematical optimization program to determine said ranking function ƒ that classifies said feature points x into said plurality of sets A, wherein for any two sets Aⁱ, A^{j}, wherein Aⁱ [symbol] A^{j}, the ranking function ƒ is a linear function of the feature points x of the form w′x, wherein w is an n-dimensional vector, the ranking function satisfying inequality constraints ƒ(xᵢ)≦ƒ(xⱼ) for all xᵢεconv(Aⁱ) and xᵢεconv(A^{j}), wherein conv(A) represents the convex hull of the elements of set A.

38. The method of claim 37, further comprising providing an ordering E={(P,Q)|A^{P} [symbol] A^{Q}} of at least some of said training data sets wherein all training samples xᵢεA^{P} are ranked higher than any sample xᵢεA^{Q}.
